(19) United States
(12) Patent Application Publication
(10) Pub. No.: US 2026/0291232 A1
(43) Pub. Date: Sep. 24, 2026

(54) SYSTEM AND METHOD FOR ENERGY MANAGEMENT

(71) Applicants: LITE-ON SINGAPORE PTE. LTD., Singapore (SG); Nanyang Technological University, Singapore (SG)

(72) Inventors: Yan CAO, Singapore (SG); Ziming YAN, Singapore (SG); Zhenyuan DU, Singapore (SG); Yan XU, Singapore (SG); Jing YANG, Singapore (SG); Jinlong WANG, Singapore (SG)

(21) Appl. No.: 19/325,715

(22) Filed: Sep. 11, 2025

Related U.S. Application Data
(60) Provisional application No. 63/774,809, filed on Mar. 20, 2025.

(51) Int. Cl. H02J 3/00; H02J 7/00; H02J 7/35

(52) U.S. Cl. CPC H02J 3/0075; H02J 3/003; H02J 7/35; H02J 7/92; H02J 2101/25; H02J 2105/42; H02J 2105/50

(57) ABSTRACT

An energy management system including at least one sensor and a controller is provided. The sensors provide environmental data. The controller is coupled to energy sources and appliances, and is configured to: receive user setting parameters and a device list file; determine appliance categories and assign decision variables based on the appliance categories; compute an electricity cost, a comfort penalty, and a health index; generate constraints based on the device list file, the user setting parameters, and the environmental data; formulate a mixed-integer programming based on the constraints; solve the mixed-integer programming equation to determine optimum operating states; and execute the operating state parameters and energy outputs based on the optimum operating states and the output power of the energy sources.

### CROSS REFERENCE TO RELATED APPLICATIONS

This application claims the benefit of U.S. Provisional Application No. 63/774,809, filed Mar. 20, 2025, the entirety of which is incorporated by reference herein.

### BACKGROUND OF THE INVENTION

### Block of the Invention

The present invention relates to systems and methods for energy management, and, in particular, it relates to home energy management optimizing appliance scheduling based on cost, health, and comfort.

### Description of the Related Art

As global energy demand increases, residential energy management has become crucial for reducing household energy costs while maintaining occupant health needs and comfort. Conventional home energy management systems (HEMS) typically rely on preset schedules or user-controlled settings, which fail to adapt to dynamic electricity pricing and evolving energy demand. Additionally, existing management systems often lack the ability to strike a balance between minimizing costs and maintaining user health and comfort. Furthermore, they do not consider weather changes and the surrounding environment of the users.

### BRIEF SUMMARY OF THE INVENTION

An embodiment of the present invention provides an energy management system, comprising at least one sensor and a controller. The sensors are configured to provide environmental data, including at least one of an indoor temperature, a humidity level, an air quality, and an occupancy status. The controller is coupled to a plurality of energy sources and a plurality of appliances.

The controller is configured to receive a device list file associated with the appliances and the energy sources, and a plurality of user setting parameters, including comfort thresholds, health requirements, appliance preferences, and weighting factors for cost, comfort, and health. The controller is further configured to determine appliance categories associated with the appliances and assign decision variables based on the appliance categories, wherein the decision variables include operating state parameters, operating periods, actual start times, and power consumption of each of the appliances. The controller is further configured to compute an electricity cost, a comfort penalty, and a health index based on the environmental data and the user setting parameters.

The controller is further configured to generate a cost-comfort-health index by applying the weighting factors to the electricity cost, the comfort penalty, and the health index. The controller is further configured to generate constraints based on the device list file, the user setting parameters, and the environmental data. The controller is further configured to formulate a mixed-integer programming equation to minimize the cost-comfort-health index based on the constraints. The controller is further configured to solve the mixed-integer programming equation to determine optimum operating states of the appliances and output power of the energy sources. The controller is further configured to execute the operating state parameters and energy outputs based on the optimum operating states and the output power of the energy sources.

An embodiment of the present invention provides a method for energy management in a smart system. The method comprises receiving a device list file associated with a plurality of appliances and energy sources, and receiving a plurality of user setting parameters including comfort thresholds, health requirements, appliance preferences, and weighting factors for cost, comfort, and health. The method further comprises determining appliance categories associated with the appliances and assigning decision variables based on the appliance categories, wherein the decision variables include operating state parameters, operating periods, actual start times, and power consumption. The method further comprises computing an electricity cost, a comfort penalty, and a health index based on environmental data generated by sensors and the user setting parameters. The method further comprises generating a cost-comfort-health index by applying the weighting factors to the electricity cost, the comfort penalty, and the health index.

The method further comprises generating constraints based on the device list file, the user setting parameters, and the environmental data. The method further comprises formulating a mixed-integer programming equation to minimize the cost-comfort-health index based on the constraints. The method further comprises solving the mixed-integer programming equation to determine optimum operating states of the appliances and output power of the energy sources. The method further comprises executing the operating state parameters and energy outputs based on the optimum operating states and the output power of the energy sources.

### BRIEF DESCRIPTION OF THE DRAWINGS

The present invention can be more fully understood by reading the subsequent detailed description and examples with references made to the accompanying drawings, wherein:

FIG. 1 shows a home energy management system (HEMS) according to embodiments of the present disclosure.

FIG. 2 is a block diagram of an adaptive scheduling module and a management platform for adaptive home energy management, according to embodiments of the present disclosure.

FIG. 3 is a flow chart of a method for energy management in a smart home according to embodiments of the present disclosure.

FIG. 4 shows an example of the management platform according to embodiments of the present disclosure.

FIG. 5A illustrates the real-time electricity price according to embodiments of the present disclosure.

FIG. 5B illustrates the respective power consumption of each of a plurality of appliances according to embodiments of the present disclosure.

FIG. 5C illustrates the respective power output and consumption of each of a plurality of energy sources according to embodiments of the present disclosure.

### DETAILED DESCRIPTION OF THE INVENTION

The following description is made to illustrate the general principles of the invention and should not be taken in a limiting sense. The scope of the invention is best determined by reference to the appended claims.

A smart home may be equipped with flexible appliances, battery systems, renewable energy systems (e.g., solar panels), and electric vehicles. To manage the smart home effectively, a home energy management system (HEMS) is introduced. For example, air conditioners may affect the user's comfort if the temperature changes too fast or too slow. Further, the surrounding environment may also affect the comfort level. For example, the indoor temperature may vary according to the distance between the user and the air conditioner (or a fan). Additionally, the sleep quality, air quality, and noise level of a smart home affect the health level of a user.

The cost is another important issue in residential energy management. Since the electricity price varies according to time, if the appliances with higher power consumption operate during a high-price period, the cost will increase. However, conventional HEMS does not consider the real-time electricity price and will proceed to turn on or off the appliances according to the user settings. Therefore, the present disclosure provides an advanced HEMS that balances the trade-off between the cost, the desired comfort, and the user's health.

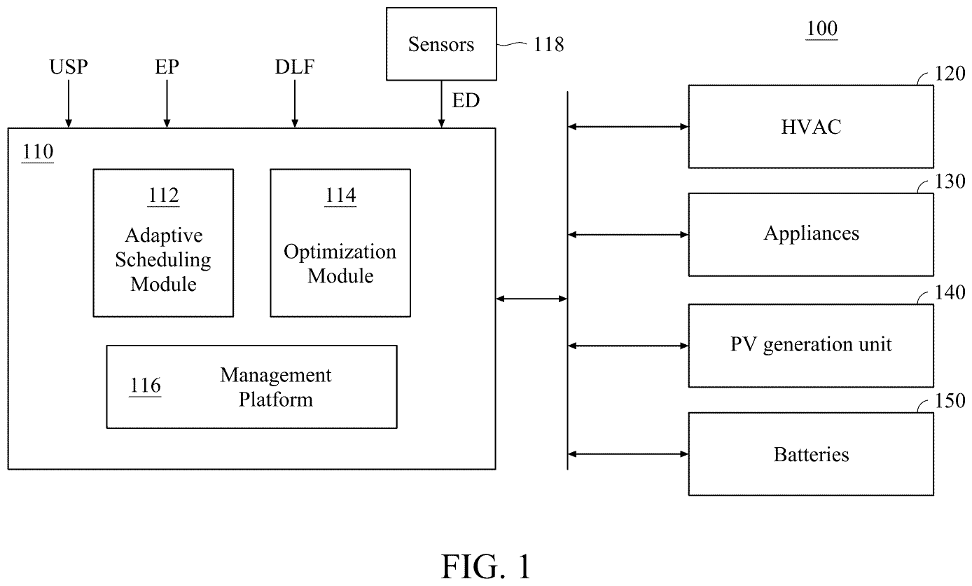

FIG. 1 shows a home energy management system (HEMS) 100 according to embodiments of the present disclosure. The HEMS 100 includes a controller 110, a plurality of sensors 118, a heating, ventilation, and air control (HVAC) system 120, a plurality of appliances 130, a photovoltaic (PV) generation unit 140, and a plurality of batteries 150.

The sensors 118 are connected to the controller 110 (through wires or wirelessly) to provide environmental data ED for adaptive energy management. For example, the environmental data ED may include indoor temperature Tin, humidity Hin, and air quality Qin. In an embodiment, the sensors 118 may be implemented in wearable devices (e.g., smartwatches or fitness trackers) that can track the user's position within the smart home. Therefore, the occupancy status of the smart home (i.e., how many rooms or which room is occupied) may also be included in the environmental data ED. Then, the controller 110 is configured to turn on or off the appliances in the occupied rooms according to the occupancy status. For example, when a user is inside room A, the lights and other possible appliances (e.g., fans) in room A may be turned on. If the user leaves room A and enters room B without closing the lights in room A, the controller 110 can determine that there is no one inside room A based on the environment data ED and turn off the lights in room A. As a result, power is turned off to unnecessary appliances, to reduce total power consumption.

The HVAC system 120 includes heaters, air conditioners, and ventilation systems configured to control the indoor temperature Tin, the humidity Hin, the air quality Qin, and other factors associated with user comfort and health levels. The appliances 130 include home appliances (e.g., TVs, washing machines, ovens, fans, refrigerators), electric vehicles, and other possible appliances. The HVAC system 120 and the appliances 130 are appliances that only consume power. Therefore, they occupy the main portion of the electricity cost. To minimize the electricity cost of the smart home while maximizing the comfort and health levels of the user, the HEMS 100 modifies the operating periods, states, and power of these appliances. Additionally, since the HVAC system 120 controls the indoor temperature Tin, the outdoor temperatures (e.g., weather or seasonal temperature variation) may also affect the operations of the HVAC system 120. Therefore, the HEMS 100 may obtain or predict the future weather to modify the indoor temperature Tin.

The PV generation unit 140 (or other types of renewable energy generation units) and the batteries 150 may be regarded as the energy sources of the smart home. The PV generation unit 140 is configured to generate and store electrical power, and to output the electrical power when the power consumption of the smart home or the real-time electricity price increases. The batteries 150 also output the stored electrical power to the smart home (i.e., discharge). However, the batteries 150 need to be recharged to regain the electrical power for the next discharge period. Therefore, the batteries 150 occupy a portion of the total power consumption of the smart home.

The controller 110 is further configured to receive user setting parameters USP, a device list file DLF, and an electricity price EP. The user setting parameters USP include parameters set by the user through a management platform 116. These parameters include comfort thresholds (e.g., temperature, humidity level, air quality thresholds, etc.), health requirements (e.g., noise level, brightness, etc.), appliance preference (e.g., predefined start times or end times), and a plurality of weighting factors W1, W2, and W3 for cost, comfort, and health, respectively. As mentioned above, the HEMS 100 is designed to balance the trade-off between electricity cost, desired comfort, and health level. Therefore, these weighting factors W1, W2, and W3 can be set according to user preference. For example, if the user prefers a higher comfort level, the weighting factor W2 may be larger than the weighting factors W1 and W3. Similarly, if the user prefers minimized cost (or maximized health level), the weighting factor W1 (or W3) may be larger than the weighting factors W2 and W3 (or W1 and W2).

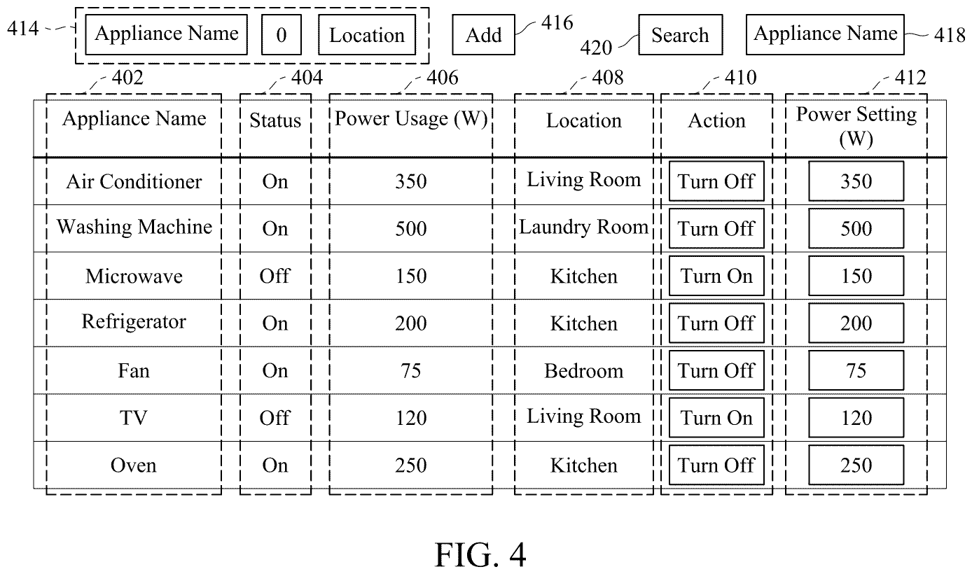

The device list file DLF may also be received by the controller 110 through the management platform 116. The product model of each appliance 130 can be used to access its detailed specification, which may include rated power, functions, etc. Therefore, with the product model of each appliance 130, the user may input (or download) the required information (e.g., rated power or power consumption for calculating the total power consumption) to the controller 110. Then, this required information may be used for energy management (see FIG. 4 with the associated description below).

The electricity price EP varies over time. For example, the electricity price EP is higher during peak hours and is lower during off-peak hours. Therefore, the instant electricity price EP is obtained from the power grids that provide power to the smart home. In an embodiment, the electricity price EP is predicted by the HEMS 100 based on the historical electricity price. Since different times of a day have different electricity prices, the HEMS 100 may control the energy sources (e.g., PV generation unit 140 and batteries 150) to discharge during peak hours to reduce the required electricity power from the power grids. As a result, the electricity cost is reduced.

The controller 110 includes an adaptive scheduling module 112, an optimization module 114, and the management platform 116. The adaptive scheduling module 112 is configured to determine the categories of the appliances 130 according to the device list file DLF and the user setting parameters USP. Then, based on the determined categories, the adaptive scheduling module 112 assigns a plurality of decision variables to the appliances 130. The decision variables include operating state parameters u, operating periods, start times t_start, or end times t_end of the appliances 130. Each operating state parameter μ may be a binary value of 0 or 1. A “0” indicates that the operating state is “OFF”, and a “1” indicates that the operating state is “ON”.

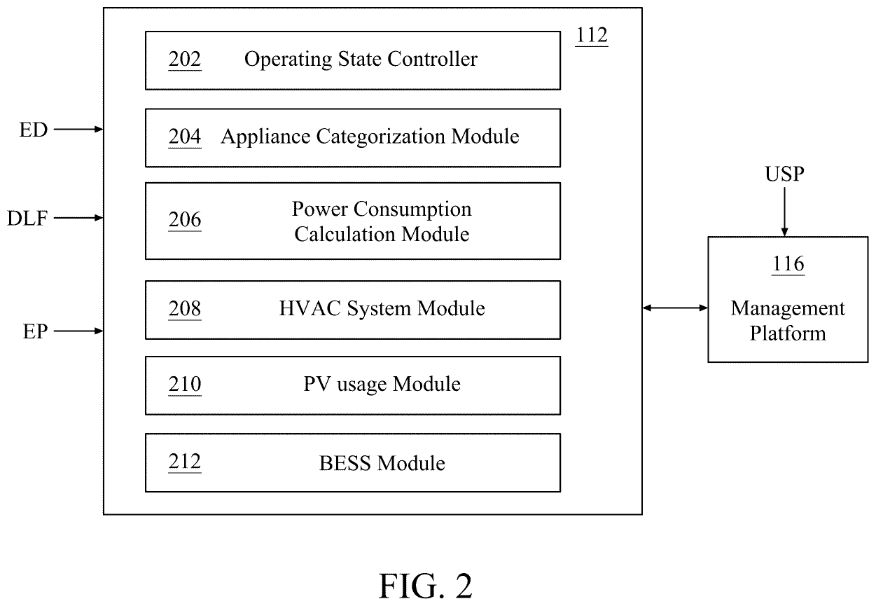

It should be noted that the start times t_start and the end times t_end are different from the predefined start and end times set by the user through the management platform 116. The start times t_start and the end times t_end are set by the adaptive scheduling module 112 based on the categories and the total operating times of the appliances 130. This will be described in detail with FIGS. 2-4 and TABLE 1 below.

Additionally, the adaptive scheduling module 112 is configured to modify the timing to turn on or off the appliances 130 and the HVAC system 120 according to the output power of the energy sources (e.g., the PV generation unit 140 and/or the batteries 150) and optimum operating states (e.g., the start times t_start, the end times t_end, and the power consumption) generated by the optimization module 114. Further, the adaptive scheduling module 112 is configured to generate constraints according to the device list file DLF, the user setting parameters USP, and the environment data ED to control the behaviors of the HVAC system 120 and the appliances 130. For example, the constraints can be minimum and maximum indoor temperatures, total operating times, or minimum and maximum power consumption.

The adaptive scheduling module 112 may also generate constraints for the PV generation unit 140 and the batteries 150. For example, the constraints may include the minimum and maximum output power of the PV generation unit 140 and the batteries 150. Additionally, the constraints may also include discharge and charge limitations of the batteries 150. In an embodiment, the batteries 150 are configured to discharge, charge, or remain inactive (i.e., do not discharge or charge).

The optimization module 114 is configured to formulate a mixed-integer programming equation to generate the optimum operating states according to the constraints. The mixed-integer programming equation is used to minimize a cost-comfort-health index CCHI associated with the desired cost, comfort, and health requirements of the user. The optimum operating states may include the start times t_start, the end times t_end, optimum temperature thresholds, discharge and charge parameters, and a plurality of optimum operating state parameters μ_op that minimize cost and maximize the comfort and health levels. When multiple appliances 130 are turned on at the same time, the power consumption may increase, requiring more power from the power grid and thereby increasing the cost. At this time, through the mixed-integer programming equation, the optimization module 114 may generate the optimum operating states with a lower cost while maintaining comfort and health levels to meet the user's preference. The detailed description of the mixed-integer programming equation will be mentioned below.

The management platform 116 is configured to provide a user interface to display the current user setting parameters USP. Additionally, the user may modify the status and the power consumption of the HVAC system 120 and the appliances 130 through the user interface. For example, the management platform 116 can be a platform (e.g., a website) that displays the information of all of the appliances 130 (including the HVAC system 120 in some embodiments) in the smart home. In another embodiment, the management platform 116 can be an application on a mobile device, such as a smartphone, a smartwatch, a laptop, etc., that displays the information of all of the appliances 130 in the smart home. Users may check and modify the status (e.g., turn on or off) and the rated power (or power consumption) of the HVAC system 120 and the appliances 130 on the platform or the application.

A detailed description of the method for energy management is provided regarding FIGS. 2-4 and TABLE 1. FIG. 2 is a block diagram of the adaptive scheduling module 112 and the management platform 116 for adaptive home energy management according to embodiments of the present disclosure. The adaptive scheduling module 112 includes an operating state controller 202, an appliance categorization module 204, a power consumption calculation module 206, an HVAC system module 208, a PV usage module 210, and a battery energy storage system (BESS) module 212. The adaptive scheduling module 112 receives the user setting parameters USP and displays the current status and power consumption of the appliances in the smart home through the management platform 116.

The operating state controller 202 modifies the operating states, such as the current status and start and end times, of the appliances 130. The appliance categorization module 204 categorizes the appliances 130 into fixed, shiftable, or interruptible appliances according to the device list file DLF and the user setting parameters USP. The power consumption calculation module 206 calculates the power consumption and the electricity cost of the smart home based on the electricity price EP and the power consumption of the HVAC system 120, the appliances 130, and the batteries 150. The HVAC system module 208, the PV usage module 210, and the BESS module 212 control the behaviors of the HVAC system 120, the PV generation unit 140, and the batteries 150, respectively.

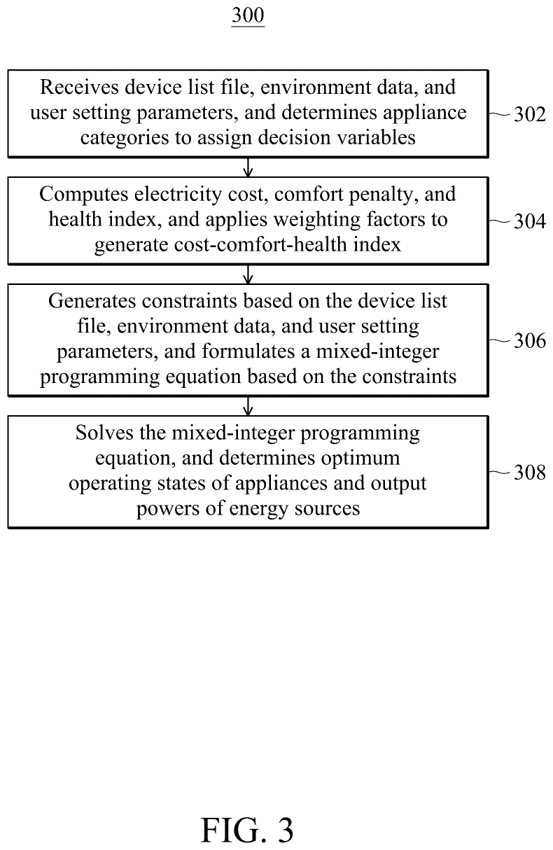

FIG. 3 is a flow chart of a method 300 for energy management in a smart home according to embodiments of the present disclosure. In step 302, the controller 110 receives the device list file DLF, the environmental data ED, the user setting parameters USP, and the electricity price EP. Then, the controller 110 determines the categories of the appliances 130 to be fixed, shiftable, or interruptible appliances, and assigns the decision variables to the appliances 130. Next, in step 304, the adaptive scheduling module 112 computes the electricity cost, the comfort penalty, and the health index based on the environment data ED, the user setting parameters USP, and the electricity price EP. Additionally, in step 306, a plurality of constraints is generated corresponding to the HVAC system 120, each of the appliances 130, the PV generation unit 140, and the batteries 150. Then, these constraints are used to formulate the mixed-integer programming equation. In step 308, the equation will be output to the optimization module 114 to solve it for determining the optimum operating states of the appliances and the energy sources in the smart home.

FIG. 4 shows an example of the user interface displayed by the management platform 116 according to embodiments of the present disclosure. Blocks 402 to 412 display the appliance names, status, power usages, locations, available actions, and power settings of the appliances 130. Additionally, the user can add new appliances through block 414 by entering the appliance names, powers, and locations of the new appliances, and click button 416 to add these appliances into the HEMS 100. The user may set the power consumption of these appliances through block 412 to modify the power usage displayed in block 406. Similarly, the user may modify the status displayed in block 404 by changing the actions in block 410.

For example, the fan in the bedroom is currently “ON”. Therefore, if the user is not in the bedroom, they can turn off the fan by pressing the “Turn Off” in block 410 to turn off the fan. As a result, the status of the fan in block 404 will now display as “Off”. Additionally, since there are many appliances in the smart home, the user may search for the desired appliance by typing the name in box 418 and clicking button 420. Through this example of the user interface displayed by the management platform, the user can modify the appliances inside the smart home at their will and at any time.

Please refer to FIGS. 2 and 3 again. TABLE 1 illustrates an example of the user setting parameters USP, the categories, and the consumed (or rated) power of the appliances 130. It is noted that the start and end times in TABLE 1 are the user setting parameters USP, not the start times t_start and end times t_end of the decision variables. In an embodiment, the user setting parameters define an allowable operation window (preferred start and end times), and the optimization determines actual start and end times as decision variables that must lie within this window.

TABLE 1

| Appliance | Power | | Start | End | Duration |
|---|---|---|---|---|---|
| Name | (W) | Category | Time | Time | (hr) |
| Smart Fridge | 800 | Fixed | 00:00 | 24:00 | 24 |
| Smart Washer | 500 | Shiftable | 07:00 | 09:00 | 1 |
| Smart Dryer | 600 | Shiftable | 09:00 | 12:00 | 2 |
| Smart Lights | 10 | Fixed | 18:00 | 23:00 | 6 |
| EV Charger | 2400 | Shiftable & | 19:00 | 06:00 | 6 |
| | | Interruptible | | | |
| Non-smart | 75 | Fixed | 12:00 | 16:00 | 4 |
| Fan | | | | | |
| Traditional | 2400 | Fixed | 17:00 | 20:00 | 3 |
| Oven | | | | | |

The appliance names, power (or energy consumption), start and end times, and operating durations are provided by the device list file DLF and the user setting parameters USP. After receiving the above information, the appliance categorization module 204 determines the category of each appliance 130. For example, assume that the electricity price varies every hour, and the controller 110 modifies the appliances 130 at a one-day interval (i.e., every 24 hours). According to the user setting parameters USP in TABLE 1, the smart fridge is set to operate from 00:00 to 24:00 with an operating duration of 24 hours. Therefore, the operation of the smart fridge cannot be shifted (since the optimization horizon (T) is 24 hours). Additionally, the smart fridge must always be “ON” to prevent the food or other items inside from spoiling. Therefore, the operation of the smart fridge cannot be interrupted. As a result, the smart fridge is categorized as a fixed appliance with a fixed operating period (e.g., 24 hours) and a fixed operating state parameter (e.g., μ is always equal to 1) during the fixed operating period.

Still referring to TABLE 1, the smart washer is set to operate from 07:00 to 09:00 with an operating duration of 1 hour. Since the available operating time (i.e., 2 hours) is longer than the operating duration, the start time t_start of the smart washer can be shifted. Therefore, the smart washer is classified as a shiftable appliance. However, since the smart washer will not stop until it finishes its operation (i.e., will not stop before the clothes are completely washed), the smart washer cannot be interrupted during its operations. As a result, the smart washer is classified as a shiftable but uninterruptible appliance with an adaptive start time and a fixed operating state parameter.

Still referring to TABLE 1, the electric vehicle (EV) charger is set to operate from 19:00 to 06:00 with an operating duration of 6 hours. Since the available operating time (i.e., 11 hours) is longer than the operating duration, the start time t_start of the EV charger can be shifted. Additionally, the EV charger can charge the EV at any time. Therefore, the operation of the EV charger is interruptible. As a result, the EV charger is classified as a shiftable and interruptible appliance with adaptive start times and end times and an adaptive operating state parameter (i.e., μu can be 1 or 0 within the available operating period).

The appliance categorization module 204 determines the categories of the appliances 130 and assigns different decision variables to each appliance 130. These decision variables are limited by constraints generated from the device list file DLF, user setting parameters USP, environment data ED, and the categories. For scheduling, a global time framework can be applied: the optimization horizon T (e.g., 24 or 72 hours) represents the total planning period, which is discretized into time steps Δt (e.g., 1 hour). All time-dependent variables and constraints are indexed by t∈{1, . . . ,T}, and decisions such as appliance states and energy source operations are updated at each time step. For example, the constraints for the operating state parameter μu are configured as follows:

$$μ\_fix = \{ \begin{matrix}1 , t ∈ [ {t}_{s} , {t}_{e} ] ( 1 a ) \\ 0 , t ∉ [ {t}_{s} , {t}_{e} ] ( 1 b )\end{matrix}$$

$$\{ \begin{matrix}μ\_shift = 0 , t ∉ [ {t}_{s} , {t}_{e} ] ( 1 c ) \\ \begin{matrix}{\sum }_{t = {t}_{s}}^{{t}_{e}} μ\_shift \geq H\_shift ( 1 d ) \\ \begin{matrix}{\sum }_{t = τ + Δ t}^{τ + H \_ shift} μ\_shift \geq H\_shift \times ( {μ\_shift}_{t + Δ t} - {μ\_shift}_{τ} ) , ( 1 e ) \\ τ ∈ [ {t}_{s} - Δ t , {t}_{e} - Δ t ]\end{matrix}\end{matrix}\end{matrix}$$

$$\{ \begin{matrix}μ\_inter = 0 , t ∉ [ {t}_{s} , {t}_{e} ] ( 1 f ) \\ {\sum }_{t = {t}_{s}}^{{t}_{e}} μ\_inter = H\_inter ( 1 g )\end{matrix}$$

where tₛ and tₑ represent the start and end time of the user setting parameters USP; μ_fix, μ_shift, and μ_inter represent the operating state parameter μ for fixed, shift, and interruptible appliances, respectively; and H_shift and H_inter represent the operating durations of the shiftable and interruptible appliances, respectively.

Regarding equations (1a) and (1b), the operating parameter μ_fix for fixed appliances is constrained to be 1 (i.e., to turn on) within the available operating time, and is constrained to be 0 (i.e., to turn off) outside the available operating time. Regarding equations (1c), the operating state parameter μ_shift for shiftable appliances is constrained to be 0 (i.e., to turn off) outside the available operating time. Additionally, regarding equation (1d), the total operating time of the shiftable appliances must meet the operating duration set by the user. Further, the shiftable appliances are appliances that have operating periods with adaptive start times and fixed operating state parameters. Therefore, equation (1e) is introduced to maintain the operating state parameter μu (e.g., maintain at “1”) while the shiftable applications are operating. Regarding equations (1f) and (1g), the operating state parameter μ_inter for interruptible appliances is also constrained to be 0 (i.e., to turn off) outside the available operating time. Additionally, the interruptible appliances are only constrained to meet the operating duration before the available operating time has passed.

Through equations (1a) to (1g), the appliances 130 are classified and controlled based on their categories. The present disclosure introduces shiftable and interruptible appliances to modify the operating periods (i.e., start times t_start and end times t_end) of the appliances 130, allowing these appliances to operate during off-peak hours, or to operate at separate periods during peak hours, thereby reducing the total power consumption and the electricity cost.

The HVAC system module 208 is configured to generate constraints to control the behavior and operating status of the HVAC system 120, such as temperature setpoints, heating or cooling rate, thermal comfort, and the thermal dynamic relationship between the indoor temperature Tin, the outdoor temperature Tout, the indoor thermal capacity, and the thermal resistance of the building envelope of the smart home. The constraints are configured as follows:

$${P}_{HVAC} = - {C}_{air} \times ( T i {n}_{t} - T i {n}_{t - 1} ) + \frac{{Tout}_{t} - T i {n}_{t}}{R} \qquad ( 2 a )$$

$$0 \leq {P}_{HVAC} \leq {P}_{HVAC \_ MAX} \qquad ( 2 b )$$

$$Ti {n}_{min} \leq Tin \leq {Tin}_{max} \qquad ( 2 c )$$

where P_{HVAC} and P_{HVAC_MAX} represent the power consumption and the maximum power consumption (or rated power) of the HVAC system 120, respectively; Cₐᵢᵣ represents the thermal capacity of the indoor air; R represents the thermal resistance of the building envelop of the smart home; Tinₜ and Touₜ, represent the indoor and outdoor temperatures at time t, respectively, and Tinₜ₋₁ represent the indoor temperatures at time t−1; Tinₘᵢₙ and Tinₘₐₓ represent the minimum and maximum acceptable indoor temperatures (i.e., the acceptable indoor temperature range), respectively.

Regarding equation (2a), the power consumption P_{HVAC} is determined based on the thermal capacity Cₐᵢᵣ of the indoor air, the difference between the previous and current indoor temperatures, and the result of dividing the difference between the current outdoor temperature and current indoor temperature by the thermal resistance R of the building envelope. However, the power consumption of the HVAC system 120 and the change rate or range of the indoor temperature Tin must be limited. For example, based on a thermal model that accounts for changes of the indoor temperature Tin, according to equations (2a) to (2c). Therefore, equations (2b) and (2c) are introduced. As a result, the power consumption P_{HVAC} is constrained to range from 0 (i.e., inactive) to the maximum power consumption P_{HVAC_MAX} (i.e., the maximum allowable output power of the HVAC system 120).

The PV usage module 210 and the battery energy storage system (BESS) 212 are configured to generate constraints to control the behaviors of the PV generation unit 140 and the batteries 150, respectively. The constraint for the PV generation unit 140 is configured as follows:

$$0 \leq {P}_{P V} \leq {P}_{PV \_ MAX} \qquad ( 3 )$$

where P_{PV} and P_{PV_MAX} represent the current output power and the maximum allowable output power of the PV generation unit 140, respectively. Equation (3) ensures that the PV generation unit 140 does not output electricity power that is too large, causing damage to the PC generation unit 140 itself.

The constraints for the batteries 150 are configured as follows:

$$0 \leq {P}_{BAT \_ DISCHAR} \leq {P}_{BAT \_ DISCHAR \_ MAX} \qquad ( 4 a )$$

$$0 \leq {P}_{BAT \_ CHAR} \leq {P}_{BAT \_ CHAR \_ MAX} \qquad ( 4 b )$$

$${μ}_{BAT \_ CHAR} + {μ}_{BAT \_ DISCHAR} \leq 1 \qquad ( 4 c )$$

$${E}_{BAT , t} = {E}_{B AT ( t - Δ t )} + {μ}_{BAT \_ CHAR} \times {P}_{BAT \_ CHAR} \times {η}_{BAT} - \frac{{μ}_{BAT DISCHAR} \times {P}_{BAT \_ DISCHAR}}{{η}_{B A T}} \qquad ( 4 d )$$

$${E}_{BAT \_ MIN} \leq {E}_{BAT} \leq {E}_{BAT \_ MAX} \qquad ( 4 e )$$

$${E}_{BAT , 0} = {E}_{B A T , T} \qquad ( 4 f )$$

As defined in Global Time & Indexing, variables are indexed by t∈{1, . . . ,T} with step Δt. Equations (4a)-(4f) apply at each time t. P_{BAT_DISCHAR} and P_{BAT_CHAR} represent the discharge and charge power of the batteries 150, respectively; P_{BAT_DISCHAR_MAX} and P_{BAT_CHAR_MAX} represent the maximum discharge and charge power of the batteries 150, respectively; E_{BAT,t} and E_{BAT(t-Δt)} are the remaining battery energy at time t and (t−Δt), respectively; μ_{BAT_CHAR} and μ_{BAT_DISCHAR} are the charge and discharge states of the batteries 150, respectively; η_{BAT} is the charge/discharge efficiency of the batteries 150; E_{BAT_MIN} and E_{BAT_MAX} are the minimum and maximum battery energy of the batteries 150, respectively; E_{BAT,0} and E_{BAT,T} are the battery energy at time t=0 and t=T, respectively.

Regarding equations (4a), (4b), and (4e), considering the health and lifespans of the batteries 150, the BESS 212 controls the maximum and minimum charge/discharge power to prevent the batteries 150 from being damaged due to deep discharge or over-charging. Additionally, equation (4c) is introduced to constrain the behavior of the batteries 150. μ_{BAT_CHAR} and μ_{BAT_DISCHAR} are state parameters that have binary values of 0 or 1, where “1” indicates that the batteries 150 are charging/discharging, and “0” indicates that the batteries 150 are not charging/discharging. Since the batteries 150 are not allowed to charge and discharge simultaneously, BESS 212 controls the state of the batteries 150 by limiting the sum of μ_{BAT_CHAR} and μ_{BAT_DISCHAR}. That is, μ_{BAT_CHAR} and μ_{BAT_DISCHAR} are configured to be both “0”, or only one of μ_{BAT_CHAR} and μ_{BAT_DISCHAR} can be set to “1” at the same time.

The battery energy E_{BAT} at time t is calculated as shown in equation (4d). Assume that the batteries 150 have operated for a duration Δt. The remaining battery energy E_{BAT,t} at time t equals the sum of the remaining battery energy E_{BAT,t-Δt} at time (t−Δt), the discharged energy, and the charged energy. The charged energy is defined as the product of the charge parameter μ_{BAT_CHAR}, the charge power P_{BAT_CHAR}, and the charge/discharge efficiency η_{BAT}. The discharged energy is defined as the product of the discharge parameter μ_{BAT_DISCHAR} and the discharge power P_{BAT_DISCHAR} divided by the charge/discharge efficiency BAT.

For management accuracy and simplicity, the BESS 212 ensures that the remaining battery energy of the batteries 150 is the same at the start and end of the operation period. For example, assume that the batteries 150 start operation with a 70% capacity. Then, the capacity of the batteries 150 will be set to 70% at the end of the operation period, no matter what operations (e.g., charge or discharge) are performed during this period. Therefore, regarding equation (4f), the remaining energy of the batteries 150 at the start (i.e., E_{BAT,0}) and end (i.e., E_{BAT,T}) of the operation period is constrained to be the same.

To balance and minimize the grid dependency of the power used in the smart home, the power consumption calculation module 206 generates constraints to determine the grid dependency of the smart home. The constraints are configured as follows:

$${p}_{G R I D} + {P}_{PV} + {μ}_{BAT \_ DISCHAR} \times {P}_{BAT \_ DISCHAR} - {μ}_{BAT \_ CHAR} \times {P}_{BAT \_ CHAR} = {P}_{l o a d} + {μ}_{E V} \times {P}_{B V} + {\sum }_{m = 1}^{M} ( {μ}_{a p p , m} \times {P}_{a p p , m} ) \qquad ( 5 )$$

where P_{GRID} represents the power bought from the power grids; μ_{BAT_DISCHAR}, μ_{BAT_CHAR}, and LEV represent the state parameters of the discharging batteries, charging batteries, and the EV, respectively; P_{BAT_DISCHAR}, P_{BAT_CHAR}, and P_{EV} represent the power consumptions of the discharging batteries, charging batteries, and the EV, respectively; μ_{app,m} and P_{app,m} represent the state parameter and the power consumption of appliance m in the smart home; P_{load} represents the powers of the other appliances of the smart home.

The total power consumption of the smart home may include the power consumption of the HVAC system 120 and appliances 130 (i.e., the μ_{app,m}×P_{app,m} and μ_{EV}×P_{EV} of equation (5)), the power used for battery charging, and the base load of the smart home (i.e., P_{load} of equation (5)). In some embodiments, the HVAC system 120 is included in the appliances 130, making “HVAC system” one of the appliance categories. These embodiments classified an appliance as part of the HVAC system 120 by user setting parameters USP related to temperature, humidity level, air quality, etc. The base load P_{load} of the smart home may be the power used to operate the HEMS 10 or control water flows in the smart home, or the power dissipated when transmitting electricity power.

The output power provided by the energy sources (e.g., PV generation unit 140 and batteries 150) includes the output power P_{PV} of the PV generation unit 140 (or other renewable power generators) and the battery discharging power. If the power provided by the energy sources is insufficient for the smart home to operate properly, the power from the power grids is needed. Therefore, the HEMS 100 can control the PV generation unit 140 to output the stored power and the batteries 150 to discharge during peak hours, and to charge the batteries 150 during off-peak hours. As a result, the power required from the grid during peak hours (i.e., the electricity price is higher) is reduced, thereby leading to a reduced cost.

The operating state controller 202 and the HVAC system module 208 are further configured to control the comfort levels associated with the shiftable appliances (which are at least a portion of the appliances 130) and the HVAC system 120, such as the thermal comfort level. The discomfort and comfort indices for the HVAC system 120 are defined as follows:

$${C}_{DISCOM \_ HVAC} = \frac{\vert {Tin}_{n e a r} - T i {n}_{b e s t} \vert}{T i {n}_{max} - T i {n}_{min}} \qquad ( 6 a )$$

$${C}_{COM \_ HVAC} = {A}_{HVAC} - {C}_{DISCOM \_ HVAC} \qquad ( 6 b )$$

and the discomfort and comfort indices for the shiftable appliances are defined as follows:

$${C}_{DISCOM \_ shift} = \frac{\vert {t}_{o n} - {t}_{b e s t} \vert}{{t}_{end} - {t}_{s t a r t}} \qquad ( 6 c )$$

$${C}_{COM \_ shift} = {A}_{shift} - {C}_{DISCOM \_ shift} \qquad ( 6 d )$$

where C_{DISCOM_HVAC} and C_{DISCOM_shift} represent the discomfort indices for the HVAC system 120 and the shiftable appliances, respectively; C_{COM_HVAC} and C_{COM_shift} represent the comfort indices for the HVAC system 120 and the shiftable appliances, respectively; Δ_{HVAC} and Δ_{shift} represent the maximum comfort values achieved by the HVAC system 120 and the shiftable appliances, respectively; Tinₙₑₐᵣ, Tin_{best}, Tinₘᵢₙ, and Tinₘₐₓ represent the nearest, preferred, minimum, and maximum indoor temperatures, respectively; tₒₙ, t_{best}, t_{end}, and tₛₜₐᵣₜ represent the actual start times, preferred start times, end times, and start times of the shiftable appliances.

Regarding equations (6a) and (6b), the discomfort index for the HVAC system 120 is determined by dividing the difference between the nearest and preferred indoor temperatures by the difference between the maximum and minimum indoor temperatures. The nearest indoor temperature Tinₙₑₐᵣ is generated by the sensors 118. For example, since the indoor temperature Tin may be non-uniform in the smart home, some of the sensors 118 may be configured to be infrared sensors that can detect and output the temperature of the surroundings and locate the user in the smart home. After determining the area where the user is in, the sensors 118 may detect the indoor temperature near the user to generate the nearest indoor temperature Tinₙₑₐᵣ. The preferred indoor temperature Tin_{beast} is set by the user (e.g., included in the user setting parameters USP). By obtaining the difference between the nearest and preferred indoor temperatures, the HVAC system module 208 may determine that the indoor temperature Tin should increase or decrease to achieve maximum comfort level.

The maximum and minimum indoor temperatures are used to determine the discomfort level caused by the difference between the nearest and preferred indoor temperatures. For example, if the difference between the nearest and preferred indoor temperatures is the same as the difference between the maximum and minimum indoor temperatures (i.e., the result of solving the equation (6a) is 1), the HVAC system module 208 determines that the current state of the HVAC system 120 generates a maximum discomfort index. If the result of solving the equation (6a) is 0 (i.e., the nearest and preferred indoor temperatures are the same), the HVAC system module 208 determines that the current state of the HVAC system 120 generates a maximum comfort index, which corresponds to the maximum comfort value ΔHVAC in equation (6b). Therefore, the comfort index C_{COM_HVAC} is determined by subtracting the discomfort index C_{DISCOM_HVAC} from the maximum comfort value ΔHVAC.

Regarding equations (6c) and (6d), the discomfort index C of the shiftable appliances is determined by dividing the difference between the actual start time and the preferred start time by the available operating period. The actual start time tₒₙ is the start time t_start of the decision variables. The preferred start time t_{best} is the start time of the user setting parameters USP (i.e., set by the user). For shiftable appliances, the actual start and end times may be modified by the adaptive scheduling module 112 to achieve lower electricity costs. As a result, some of the shiftable appliances may not be activated according to the preferred time set by the user. Therefore, the available start and end times (i.e., tₛₜₐᵣₜ and t_{end} of equation (6c)) are used to determine the discomfort level caused by the difference between the actual start time and the preferred start time.

For example, assume that the available operating time ranges from 07:00 to 09:00, the shiftable appliance has to achieve an operating duration of 30 minutes, and the user sets the preferred start time t_{best} at 07:00. If the actual start time is set to 07:00 (i.e., the same as the preferred start time), then the discomfort index C_{DISCOM_shift} equals 0. That is, the minimum discomfort index of this shiftable appliance is determined. As a result, the maximum comfort index C_{COM_shift} (or A_{shift} of equation (6d)) is determined. In another embodiment, the actual start time may be shifted from 07:00 to 08:30 (i.e., the latest allowable start time), thereby generating the maximum discomfort index C_{DISCOM_shift} and the minimum comfort index C_{COM_shift} of this shiftable appliance.

The HVAC system module 208 is further configured to modify the health level of the smart home. The health level may be affected by different factors, such as sleep quality, respiratory conditions, and stress level. A health index HI is determined based on the environmental data ED, such as the indoor temperature Tin, the humidity Hin, and the air quality Qin.

The sleep quality is determined using the sleep quality index SQI, which is determined based on various environmental, physiological, and behavioral parameters, such as indoor temperature, humidity level, air quality, light exposure level, noise level, and the consistency and timing of sleep periods. Therefore, the sleep quality index SQI may be defined as follows:

$$SQI = f ( Tin , Hin , L , N , Qin , {C}_{SLEEP} ) \qquad ( 7 )$$

where Tin, Hin, and Qin represent the indoor temperature, humidity level, and air quality, respectively; L and N represent the light exposure and noise levels, respectively; C_{SLEEP} represents the consistency in the user's sleep and wake-up timings.

The consistency C_{SLEEP} in the user's sleep and wake-up timings is related to the indoor temperature Tin, the humidity Hin, the air quality Qin, the light exposure level L, and the noise level N. Therefore, by modifying these parameters and formulating equation (7) (which is related to these parameters), the sleep quality index SQI may represent the user's sleep quality. For example, assume a better sleep quality indicates a longer consistency of sleep time and fewer wake-up times. Accordingly, equation (7) represents the relationship between the consistency of sleep time and wake-up times of the user, and the indoor temperature Tin, the humidity Hin, the air quality Qin, the light exposure level L, and the noise level N. The change in Consistency C_{SLEEP} represents the impact of these parameters on the sleep quality of the user. Therefore, by solving equation (7), the optimum combination of the indoor temperature Tin, the humidity Hin, the air quality Qin, the light exposure level L, and the noise level N can be found, and the corresponding sleep quality index SQI can be determined.

The respiratory condition is determined using the respiratory condition index RCI, which is determined based on air quality, indoor temperature, ventilation rate, and allergen level. Therefore, the respiratory condition index RCI may be defined as follows:

$$RCI = f ( Qin , Tin , Hin , {R}_{V} , AL ) \qquad ( 8 )$$

where Qin, Tin, Hin, R_{V}, and AL represent the air quality, indoor temperature, humidity level, ventilation rate, and allergen level, respectively. By solving equation (8), i.e., determining the optimum combination of the air quality, indoor temperature, humidity level, ventilation rate, and allergen level for the user, the maximum respiratory condition index RCI is determined. For example, these parameters may be controlled by the HVAC system module 208 through modification of the HVAC system 120, air purifiers, humidifiers, and ventilation.

The stress relief index SRI is affected by various environmental data ED, such as indoor temperature, humidity level, light exposure level, noise level, air quality, and scent level. To reduce the stress of the user living in the smart home, the indoor temperature Tin may be set to the preferred indoor temperature (e.g., set by the user), and the humidity level, air quality, light exposure level, and noise level may be similar to the parameters for achieving the maximum comfort level. The stress relief index SRI may be defined as follows:

$$SRI = f ( Tin , Hin , L , N , Qin , SL ) \qquad ( 9 )$$

where Tin, Hin, L, N, Qin, and SL represent the indoor temperature, humidity level, light exposure level, noise level, air quality, and scent level. By solving equation (9), i.e., determining the optimum combination of these parameters, the maximum stress relief condition index SRI is determined. For example, the HEMS 100 may create a less stressful (i.e., with a higher stress relief index SRI) by dimming the lights (i.e., lowering the light exposure level) in the evening, keeping the indoor temperature and humidity within a preferred range, reducing noise, playing calming sounds (e.g., white noise), releasing soothing scents, etc.

After defining the sleep quality index SQI, the respiration condition index RCI, and the stress relief index SRI, the health index HI is configured as follows:

$$H I = f ( S QI , RCI , SRI ) \qquad ( 10 )$$

Through equation (10), the relationships between the parameters used to determine the sleep quality index SQI, the respiration condition index RCI, and the stress relief index SRI are represented by the health index HI. Therefore, by solving equation (10), the optimum health level for the user can be achieved.

Now that the total power consumption, the comfort index (or comfort penalty), and the health index of the smart home are all determined, the HEMS 100 proceeds to introduce the weighting factors W1, W2, and W3 corresponding to the total power consumption, the comfort index, and the health index to balance the trade-off between the cost, comfort, and health. Referring to the following equations (11a) to (11e), where Δt denotes the discretization step (e.g., 1 h) and T denotes the optimization horizon:

$${C}_{cost \_ min} = {\sum }_{t = 1}^{T} ( E {P}_{t} \times {P}_{G R I D} \times Δ t ) \qquad ( 11 a )$$

$${C}_{COM \_ MAX} = {\sum }_{t = 1}^{T} {\sum }_{m = 1}^{M} {C}_{COM} ( m , t ) \qquad ( 11 b )$$

$${C}_{DISCOM \_ MIN} = - {C}_{COM \_ MAX} \qquad ( 11 c )$$

$${HI}_{MAX} = {\sum }_{t = 1}^{T} H {I}_{t} \qquad ( 11 d )$$

$$OMP = W 1 \times {C}_{cost \_ min} + W 2 \times {C}_{DISCOM \_ MIN} + W3 \times {HI}_{MAX} \qquad ( 11 e )$$

where EPₜ and P_{GRID} represent the electricity price and the power bought from the grids, respectively. At represent the discretization step (e.g., 1 hour) and T represents the optimization horizon (e.g., 24 or 72 hours), applied consistently across all time-dependent variables; C_{COM_MAX}, C_{DISCOM_MIN}, and C_{COM}(m,t) represent the maximum comfort index, minimum discomfort index (or minimum comfort penalty), and the comfort index of appliance m at time t, where M is the number of the appliances 130; HI_{MAX} represents the maximum health index; OPM represents the solution to a mixed-integer programming equation (11e) based on equations (1a) to (11d).

The weighting factors W1, W2, and W3 correspond to cost, comfort, and health. These factors allow the user to prioritize cost, comfort, or health, ensuring the modification preference of the HEMS 100 and the flexibility in adapting to individual household preferences.

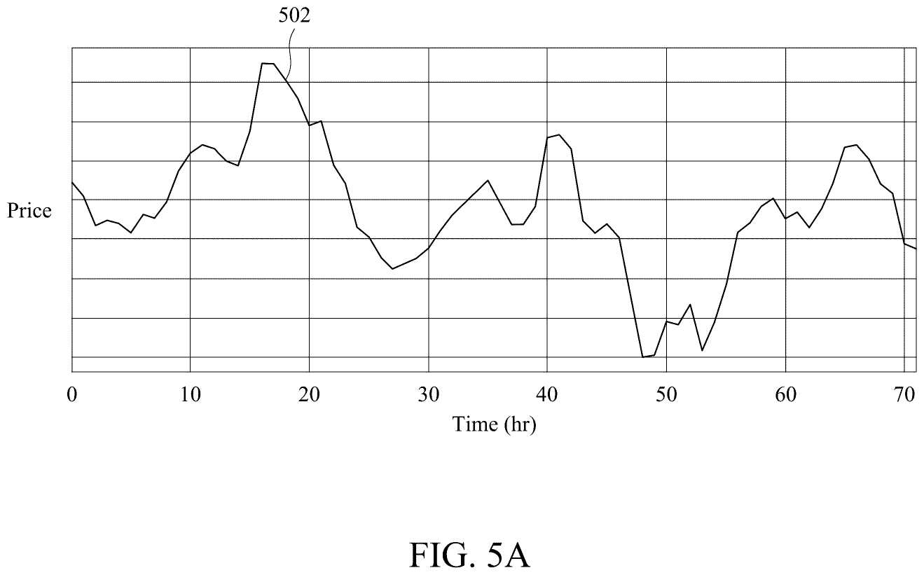

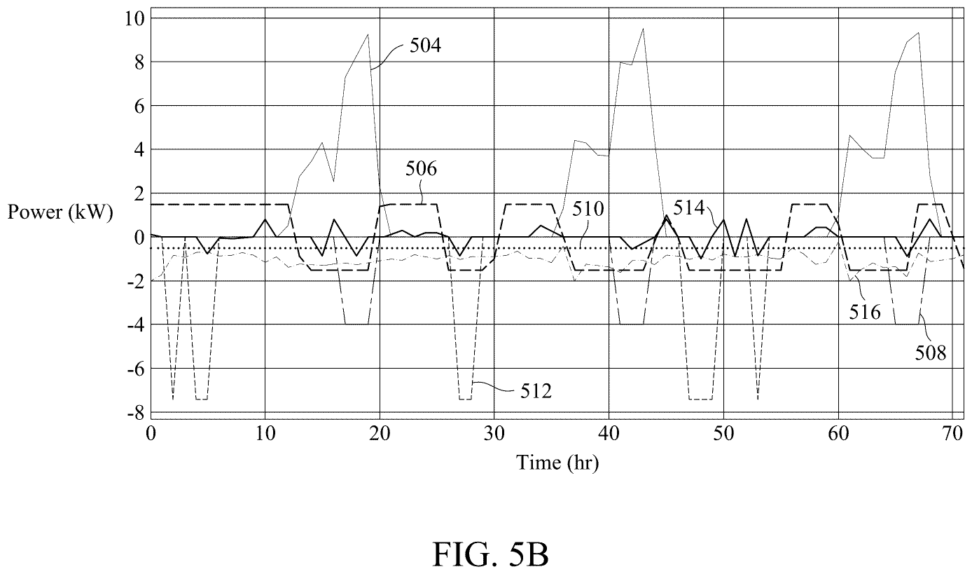

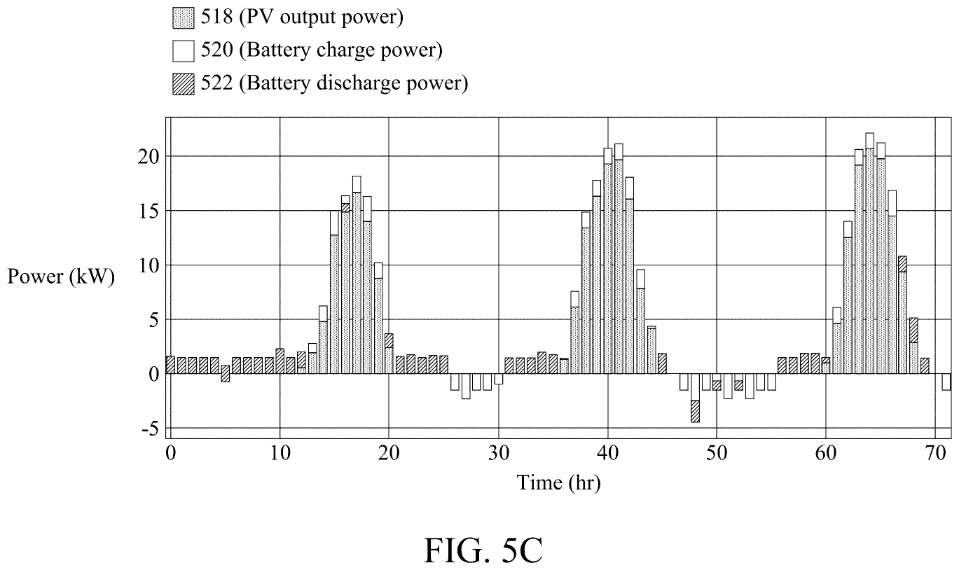

FIGS. 5A to 5C illustrate the real-time electricity price EP, the respective power consumption of each appliance, and the respective output/power consumption of each energy source, according to embodiments of the present disclosure. In an embodiment, an optimization horizon of 72 hours is assumed. The HEMS generates a schedule for the horizon covering all appliances and energy sources, and may perform rolling re-optimization within the horizon when electricity prices or user settings change, rather than waiting until the end of the 72-hour period.

Regarding FIG. 5A, line 502 represents the electricity price EP from the power grids within 72 hours. The peak hours in a day are the periods with a relatively higher electricity price, such as the 16th~21st hours in the first 24-hour period (i.e., the first day), the 38th~45th hours in the second 24-hour period (i.e., the second day), and the 61st~70th hours in the third 24-hour period (i.e., the third day). The off-peak hours of a day are periods marked by a relatively low electricity price, such as the 0th~10th hours in the first 24-hour period (i.e., the first day), the 24th~33rd hours in the second 24-hour period (i.e., the second day), and the 48th~50th hours in the third 24-hour period (i.e., the third day).

Regarding FIG. 5B, lines 504 to 516 represent the power consumption and output power of the appliances and energy sources controlled by the HEMS 100, where power with a value lower than 0 is regarded as power consumption, and power with a value higher than 0 is regarded as output power. For example, lines 504 to 516 represent the power of the PV generation unit 140, a first battery, ovens, fridges, EV chargers, a second battery, and the HVAC system 120. Therefore, line 504 shows values that are not less than 0, since the PV generation unit 140 only outputs power. Both lines 506 and 514 show values that are greater than 0 as well as values that are less than 0, since each of the batteries 150 may be discharging (i.e., outputting the stored power) or charging (i.e., consuming power). Lines 508, 510, 512, and 516 show values that are not greater than 0, since the HVAC system 120 and appliances 130 (e.g., ovens, fridges, EV chargers, etc.) only consume power.

In FIG. 5B, lines 508, 510, 512, and 514 represent ovens, fridges, EV chargers, and the HVAC system 120. Regarding TABLE 1, fridges (or smart fridges) are classified as fixed appliances, ovens (or smart fridges) are classified as fixed appliances, and EV chargers are classified as interruptible appliances. Therefore, line 510 has a fixed power consumption since the fridges have fixed operating state parameters. Ovens typically operate during cooking times and are activated during a particular period. EV chargers can operate at any time within the available operating period and are activated during off-peak hours.

The power consumption of the HVAC system 120 is affected by the surrounding environment of the smart home. For example, as shown in FIG. 5B, the power consumption of the HVAC system 120 is relatively higher from noon to evening (e.g., the 36th~43rd hours, or 12:00 to 17:00 of the second day) compared with the power consumption of other times in a day (e.g., from 45th~55th hours, or 21:00 of the second day to 7:00 of the third day).

In FIGS. 5A and 5B, it may be noted that shiftable and/or interruptible appliances are activated during off-peak hours if possible. Additionally, as shown in FIG. 5C, the batteries 150 are charged during off-peak hours if possible. When it is not possible to shift or interrupt an appliance's operations, the energy sources (e.g., the PV generation unit 140 and the batteries 150) discharge the stored power to reduce the power required from the grids. For example, the PV generation unit 140 outputs its power during the 12th~21st hours, which are the peak hours of the first day. Additionally, batteries 150 may discharge to reduce the power required from the grids at any time, and charge during off-peak hours or when the PV generation unit 140 outputs its power.

The HEMS 100 described in the present disclosure is suitable for residential applications, particularly in homes equipped with smart appliances, HVAC, EV, PV units, and BESS. It optimizes power consumption and storage while considering user comfort, health, and seasonal conditions, leading to reduced costs, enhanced energy efficiency, improved living conditions, and overall occupant wellness. This system is adaptable to various home sizes and configurations, making it a versatile solution for modern energy management challenges.

Additionally, by incorporating data from wearables and Internet-of-Things (IOT) health monitors, the HEMS can modify comfort settings to support health needs such as sleep quality, respiratory conditions, and stress relief, further enhancing the residential experience. For example, the system could adjust humidity and temperature during sleep to promote better rest or modify lighting and noise for stress relief in the evening, dynamically managing appliances to support overall wellness.

This advanced HEMS provides a comprehensive solution for optimizing residential energy consumption by incorporating real-time electricity pricing data, appliance flexibility modules, predictive analytics, health-driven comfort adjustments, seasonal comfort settings, and a cost-comfort-health trade-off optimization. This HEMS continuously monitors electricity prices, appliance usage, health data, weather forecasts, and user preferences, enabling real-time optimization through a user-friendly interface. This combination of adaptive scheduling algorithms, dynamic feedback loops, and machine learning predictions effectively addresses the limitations of traditional energy management solutions, which are often static and less responsive to changing conditions. The system can anticipate seasonal changes (e.g., heating needs in winter) or adjust for daily weather forecasts (e.g., reducing HVAC use on cooler days), optimizing for both comfort and energy efficiency.

In contrast to conventional systems that only react to current electricity prices and user preferences, this HEMS actively anticipates future conditions, making it a highly effective tool for sustainable energy management. By forecasting user comfort needs, health requirements, seasonal changes, appliance usage patterns, and potential cost-saving opportunities, the HEMS optimizes appliance schedules based on both immediate and expected conditions. This forward-looking capability allows homeowners to enjoy energy savings while maintaining a high level of comfort, health, and energy efficiency, a feature typically absent in traditional systems that lack predictive analytics and adaptive algorithms.

The HEMS also enhances user experience with detailed appliance control, monitoring, and visualization functions, which allow users to manage and adjust their energy usage, comfort settings, and health conditions more precisely. Unlike traditional energy management systems, this advanced HEMS provides a dynamic, responsive platform capable of real-time adjustments and future-oriented optimization. Its flexibility and scalability make it suitable for diverse residential settings, allowing homeowners to tailor energy usage, health settings, and seasonal comfort to their unique needs and preferences, thereby fostering a sustainable and comfortable living environment. This adaptability ensures that the HEMS can effectively adjust comfort settings based on weather conditions and seasonal changes, promoting optimum indoor conditions year-round. It ensures that the HEMS can be effectively applied across various home environments and energy market conditions, promoting efficient, sustainable, and health-oriented energy conservation at the residential level.

The following paragraphs further describe exemplary operations of the controller 110 for generating and activating optimized appliance schedules, as well as clarifying the interpretation of certain terms used in a layered or iterative context.

In an embodiment, the controller 110 receives a device list file and user setting parameters including comfort thresholds, health requirements, appliance preferences, and weighting factors for cost, comfort, and health. Based on these inputs, the controller 110 determines appliance categories (fixed, shiftable, interruptible) and assigns decision variables including operating state parameters, operating periods, actual start times, and power consumption for each appliance. The controller 110 formulates a mixed-integer programming equation using constraints derived from the device list file, user setting parameters, and environmental data, and computes an objective function that minimizes a cost-comfort-health index. The optimization horizon T (e.g., 24 or 72 hours) is discretized into time steps Δt (e.g., 1 hour), and the algorithm generates an initial schedule specifying appliance start times, end times, and energy source operations. FIG. 2 and FIG. 3 illustrate these generation steps, including the assignment of decision variables and the creation of constraints for HVAC, PV, and BESS components.

In another embodiment, the controller 110 activates the generated schedule by executing the operating state parameters and energy outputs for the appliances and energy sources. During execution, the controller 110 monitors real-time electricity prices, environmental data, and user settings. Upon detecting a trigger condition such as a price change or updated comfort requirement within the optimization horizon, the controller 110 performs rolling re-optimization by updating relevant inputs and reapplying the same scheduling algorithm to generate a revised schedule for the remaining time steps. While the active schedule is in use, the controller 110 may continue background generation of successor schedules for updated conditions, ensuring continuity of cost, comfort, and health objectives. FIG. 5A illustrates this iterative adjustment process under dynamic pricing scenarios.

In some embodiments, the term “configured to” as used in the claims is to be understood as requiring the controller 110 to include executable instructions and associated hardware resources that perform the disclosed steps of receiving inputs, generating constraints, solving the optimization model, and activating the resulting schedule, consistent with the algorithms and structures described herein.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An energy management system, comprising:
at least one sensor, configured to provide environmental data including at least one of an indoor temperature, a humidity level, an air quality, or an occupancy status; and
a controller, coupled to a plurality of energy sources and a plurality of appliances, wherein the controller is configured to:
receive a device list file associated with the appliances and the energy sources, and a plurality of user setting parameters including comfort thresholds, health requirements, appliance preferences, and weighting factors for cost, comfort, and health;
determine appliance categories associated with the appliances and assign decision variables based on the appliance categories, wherein the decision variables include operating state parameters, operating periods, actual start times, and power consumption of each of the appliances;
compute an electricity cost, a comfort penalty, and a health index based on the environmental data and the user setting parameters;
generate a cost-comfort-health index by applying the weighting factors to the electricity cost, the comfort penalty, and the health index;
generate constraints based on the device list file, the user setting parameters, and the environmental data;
formulate a mixed-integer programming equation to minimize the cost-comfort-health index based on the constraints;
solve the mixed-integer programming equation to determine optimum operating states of the appliances and output power of the energy sources; and
execute the operating state parameters and energy outputs based on the optimum operating states and the output power of the energy sources.

2. The energy management system as claimed in claim 1, wherein each of the operating state parameters is a binary value of 0 or 1.

3. The energy management system as claimed in claim 1, wherein the controller comprises:
an adaptive scheduling module, configured to classify the appliance categories as a fixed appliance, a shiftable appliance, or an interruptible appliance based on the device list file and the user setting parameters; and
a management platform, configured to display a user interface associated with the user setting parameters and to provide instant modifications to the user setting parameters.

4. The energy management system as claimed in claim 1, wherein the controller is further configured to compute the electricity cost, the comfort penalty, and the health index based on a total power consumption associated with an appliance power consumption and a heating, ventilation, and air control (HVAC) power consumption, and wherein:
the appliance power consumption is calculated using the user setting parameters and power ratings of the appliances; and
the HVAC power consumption is calculated based on a thermal model that accounts for changes in the indoor temperature, a difference between the indoor temperature and an outdoor temperature, a thermal capacity of indoor air, and a thermal resistance of a building envelope.

5. The energy management system as claimed in claim 4, wherein the constraints further comprise HVAC control constraints, including:
a maximum HVAC power output;
an acceptable indoor temperature range; and
a thermal dynamic relationship between the indoor temperature, the outdoor temperature, an indoor thermal capacity, and a thermal resistance of the building envelope.

6. The energy management system as claimed in claim 4, wherein the energy sources comprise:
a battery energy storage system (BESS), configured to determine a battery charge power and a battery discharge power of a plurality of batteries; and
a photovoltaic (PV) (or renewable energy) generation unit, configured to output a PV output power within a maximum PV output power threshold,
wherein the total power consumption further includes the battery charge power; and
wherein the output power includes the battery discharge power and the PV output power.

7. The energy management system as claimed in claim 6, wherein a battery energy of the BESS is determined by:
calculating a first product of the battery charge power, a charge parameter, and a charge efficiency;
calculating a second product of the battery discharge power, a discharge parameter, and a discharge efficiency; and
determining the battery energy based on a sum of a previous battery energy and a difference between the first product and the second product.

8. The energy management system as claimed in claim 7, wherein each of the charge parameter and the discharge parameter is a binary value of 0 or 1, and a sum of the charge parameter and the discharge parameter does not exceed 1.

9. The energy management system as claimed in claim 7, wherein the controller is further configured to set the battery energy at an end of an operating period of the BESS as an initial battery energy at a start of the operating period of the BESS.

10. The energy management system as claimed in claim 6, wherein the electricity cost is determined by multiplying a real-time electricity price by a difference between the output power and the total power consumption.

11. The energy management system as claimed in claim 3, wherein:
the fixed appliance is associated with a fixed operating period and a fixed operating state parameter;
the interruptible appliance is associated with an adaptive operating state parameter within an operating period of the interruptible appliance; and
the shiftable appliance is associated with a shiftable operating period having an adaptive start time.

12. The energy management system as claimed in claim 11, wherein the adaptive scheduling module is further configured to:
set up the appliance categories being a heating, ventilation, and air control (HVAC) system with variables associated with the indoor temperature, an indoor temperature change rate, and a thermal comfort based on the user setting parameters and the environmental data;
calculate a HVAC discomfort index by dividing a first difference by a second difference in response to the appliance categories being the HVAC system, wherein the first difference is defined as a difference between the indoor temperature provided by the at least one sensor and a predefined indoor temperature set by a user, and the second difference is defined as a difference between a maximum indoor temperature and a minimum indoor temperature provided by the at least one sensor; and
determining an HVAC comfort index based on a difference between a maximum comfort index of the HVAC system and the HVAC discomfort index.

13. The energy management system as claimed in claim 11, wherein in response to the appliance categories not being a heating, ventilation, and air control (HVAC) system, the controller is further configured to:
calculate an appliance discomfort index by dividing a first difference by a second difference, wherein the first difference is defined as a difference between the actual start time and a predefined start time of each of the appliances, and the second difference is defined as the operating period of each of the appliances; and
determine an appliance comfort index based on a difference between a maximum comfort index of the appliances and the appliance discomfort index.

14. The energy management system as claimed in claim 11, wherein the operation of determining the comfort penalty further comprises:
adding an appliance comfort index of each of the appliances and a heating, ventilation, and air control (HVAC) comfort index of an HVAC system to generate a total comfort index; and
determining the comfort penalty by taking a negative of the total comfort index.

15. The energy management system as claimed in claim 1, wherein the operation of determining the health index further comprises:
determining a sleep quality index (SQI) based on the indoor temperature, the humidity level, a light exposure level, a noise level, the air quality, and a consistency in sleep timing;
determining a respiratory condition index (RCI) based on the air quality, the humidity level, the indoor temperature, an allergen level, and a ventilation rate;
determining a stress relief index (SRI) based on the indoor temperature, the humidity level, the light exposure level, the noise level, the air quality, and a scent level; and
determining the health index based on the SQI, the RCI, and the SRI.

16. The energy management system as claimed in claim 1, wherein the cost-comfort-health index is generated by adding a first product of the electricity cost and the weighting factor for cost, a second product of the comfort penalty and the weighting factor for comfort, and a third product of the health index and the weighting factor for health.

17. The energy management system as claimed in claim 1, wherein the controller further comprises an optimization module configured to:
determine a predicted electricity price and predicted environment data, modify the actual start times and the operating state parameters of each of the appliances according to the appliance categories and the occupancy status, and modify the output power of the energy sources, to generate an optimum cost-comfort-health index and a predicted electricity cost that is lower than the electricity cost.

18. A method for energy management in a smart system, comprising:
receiving a device list file associated with a plurality of appliances and energy sources, and receiving a plurality of user setting parameters including comfort thresholds, health requirements, appliance preferences, and weighting factors for cost, comfort, and health;
determining appliance categories associated with the appliances and assigning decision variables based on the appliance categories, wherein the decision variables include operating state parameters, operating periods, actual start times, and power consumption;
computing an electricity cost, a comfort penalty, and a health index based on environmental data generated by sensors and the user setting parameters;
generating a cost-comfort-health index by applying the weighting factors to the electricity cost, the comfort penalty, and the health index;
generating constraints based on the device list file, the user setting parameters, and the environmental data;
formulating a mixed-integer programming equation to minimize the cost-comfort-health index based on the constraints;
solving the mixed-integer programming equation to determine optimum operating states of the appliances and output power of the energy sources; and
executing the operating state parameters and energy outputs based on the optimum operating states and the output power of the energy sources.

19. The method as claimed in claim 18, wherein each of the operating state parameters is configured to be a binary value of 0 or 1.

20. The method as claimed in claim 18, wherein the operation of determining the electricity cost further comprises:
using the user setting parameters and power ratings of the appliances to calculate an appliance power consumption; and
calculating a heating, ventilation, and air control (HVAC) power consumption based on a thermal model that accounts for changes in an indoor temperature, a difference between the indoor temperature and an outdoor temperature, a thermal capacity of indoor air, and a thermal resistance of a building envelope;
determining a PV output power, a battery charge power, and a battery discharge power of the energy sources;
determining a total power consumption based on the HVAC power consumption, the appliance power consumption, and the battery charge power, and determining the output power based on the battery discharge power and the PV output power; and
determining the electricity cost based on a real-time electricity price and a difference between the output power and the total power consumption,
wherein each of a charge parameter and a discharge parameter of the energy sources is configured to be a binary value of 0 or 1, and a sum of the charge parameter and the discharge parameter does not exceed 1.

21. The method as claimed in claim 18, wherein the operation of modifying the operating state parameters further comprises:
determining the appliance categories of each of the appliances based on characteristics of the appliances, and modifying an operating setting of each of the appliances based on the appliance categories,
wherein the appliance categories include:
a fixed appliance with a fixed operating period and a fixed operating state parameter;
an interruptible appliance with an adaptive operating state parameter within an operating period of the interruptible appliance;
a shiftable appliance with a shiftable operating period having an adaptive start time; and
a heating, ventilation, and air control (HVAC) system, configured to control an indoor temperature, power consumption setting, and a thermal comfort based on the user setting parameters and the environmental data.

22. The method as claimed in claim 21, wherein the operation of determining the comfort penalty further comprises:
determining a HVAC comfort index based on a difference between a maximum comfort index of the HVAC system and a HVAC discomfort index, wherein the HVAC discomfort index is determined based on the indoor temperature, a predefined indoor temperature, a maximum indoor temperature, and a minimum indoor temperature; and
determining an appliance comfort index based on a difference between a maximum comfort index of the appliance and an appliance discomfort index, wherein the appliance discomfort index is determined based on an actual start time, a predefined start time, and the operating period of each of the appliances.

23. The method as claimed in claim 22, further comprising:
adding the appliance comfort index of each of the appliances and the HVAC comfort index of the HVAC system to generate a total comfort index; and
determining the comfort penalty by taking a negative of the total comfort index.

24. The method as claimed in claim 18, wherein the operation of determining the health index further comprises:
determining a sleep quality index (SQI) based on an indoor temperature, a humidity level, a light exposure level, a noise level, an air quality, and a consistency in sleep timing;
determining a respiratory condition index (RCI) based on the air quality, the humidity level, the indoor temperature, an allergen level, and a ventilation rate;
determining a stress relief index (SRI) based on the indoor temperature, the humidity level, the light exposure level, the noise level, the air quality, and a scent level; and
determining the health index based on the SQI, the RCI, and the SRI.

25. The method as claimed in claim 18, wherein the operation of generating the cost-comfort-health index further comprises:
adding a first product of the electricity cost and the weighting factor for cost, a second product of the comfort penalty and the weighting factor for comfort, and a third product of the health index and the weighting factor for health.

26. The method as claimed in claim 18, further comprising:
determining a predicted electricity price and predicted environment data, modifying the actual start times and the operating state parameters of each of the appliances according to the appliance categories, and modifying the output power of the energy sources, to generate an optimum cost-comfort-health index and a predicted electricity cost that is lower than the electricity cost.
